(19) United States
(12) Patent Application Publication
(10) Pub. No.: US 2014/0279316 A1
(43) Pub. Date: Sep. 18, 2014

(54) APPARATUS, METHOD, AND COMPUTER READABLE MEDIUM FOR DISPLAYING GENERAL LEDGER FUNDS IN A CHECKBOOK FORMAT

(71) Applicant: TEMPLE UNIVERSITY - OF THE COMMONWEALTH SYSTEM OF HIGHER EDUCATION, PHILADELPHIA, PA (US)

(72) Inventors: Patricia J. Russo, Cherry Hill, NJ (US); Juan M. Abreu, Folcroft, PA (US)

(73) Assignee: Temple University - Of the Commonwealth System of Higher Education, Philadelphia, PA (US)

(21) Appl. No.: 14/354,485

(22) PCT Filed: Nov. 7, 2012
(86) PCT No.: PCT/US2012/063856

§ 371 Date: Apr. 25, 2014

Related U.S. Application Data
(60) Provisional application No. 61/558,226, filed on Nov. 10, 2011.

(51) Int. Cl. G06Q 40/00; G06Q 10/10

(52) U.S. Cl. CPC G06Q 40/12; G06Q 10/10
USPC 705/30

(57) ABSTRACT

Apparatus, computer readable medium, and a method for interacting with a user on a computer for displaying grants, the method comprising displaying grants with an icon indicating a balance of the grant; and in response to a selection of one of the displayed grants comprising transactions by the user, displaying transactions of the selected grant in a row comprising a column for transactions that lower the balance, a column for transactions that raise the balance, and a column for the balance, and displaying an icon for the column for transactions that lowers the balance and an icon for the column for transactions that raises the balance. The method may comprise retrieving credits and debits and displaying in the column for transactions that lower the balance, credits and debits that lower the balance, and displaying in the column for transactions that raise the balance, credits and debits that raise the balance.

### CROSS REFERENCE TO RELATED APPLICATION

This application claims the benefit of U.S. Provisional Patent Application 61/558,226, filed Nov. 10, 2011, the entire disclosure of which is incorporated herein by reference.

### FIELD

The invention relates to apparatuses, computer readable medium, and methods of interacting with a user on a computer for displaying general ledger funds in a checkbook format.

### BACKGROUND

In the discussion of the background that follows, reference is made to certain structures and/or methods. However, the following references should not be construed as an admission that these structures and/or methods constitute prior art. Applicants expressly reserve the right to demonstrate that such structures and/or methods do not qualify as prior art.

Most organizations maintain financial information in a general ledger. The general ledger helps organizations comply with Generally Accepted Accounting Principles (GAAP), which is specified by the Financial Accounting Standards Board (FASB). The general ledger is organized into different accounts that represent major classifications such as revenue, expenses, etc. The general ledger uses a double entry form of accounting where one account is credited and another is debited. The general ledger is well suited for accountants to perform tasks such as report on the financial state of the organization, file tax returns, and comply with GAAP.

However, often people in an organization who are not accountants need to obtain information from the general ledger. For example, at a university the financial records are kept in a general ledger, and university researchers often receive research grants to perform research. The researcher or non-accountant may be responsible for managing the research grant, but the grant money must be recorded in the general ledger of the university so that the university can insure compliance with GAAP and generate financial statements. The researcher or non-accountant may find it difficult to access and interpret the accounting information provided by a general ledger in order to administer their research grant.

For example, FIG. 1 illustrates an example of a financial query provided by a general ledger program of an enterprise resource planning system. The financial query 100 requires that the researcher or non-accountant be familiar with terms such as “fiscal year” 102, “fiscal period” 104, and “Chart of Accounts” 106. Moreover, the researcher or non-accountant may have to know a fund 108, an organization 110, and grant 112. Additionally, in many general ledger programs the period used to determine the information returned may vary. For example, if only a grant number 112 is entered all the data from inception of the grant to present may be returned, whereas if a fund 108 and organization 110 are entered, only fiscal year 102 information may be returned.

FIG. 2 illustrates the results of the query 100 from FIG. 1. The information returned is for grant “240055” 202 (see FIG. 3) from inception of the grant through Sep. 10, 2011, 204 (see FIG. 3). The information returned is organized into a number of accounts 206. For example account “7240” 208 has an account title 210 “Business Supplies and Service”, an adjusted budget 212 of “0”, an accounted budget 212 of “0”, an year to date 216 of “2,043.00”, an encumbrance 218, and available balance 220 of “(2,043.00)”. The report total (of all records) 222 provides the adjusted budget 212 of “200,000.00” 224 and the “available budget” 220 of “11,069.28.”

FIG. 3 illustrates the results of a user selecting account 206 “7240” 208 of FIG. 2. Three transactions with transaction dates 302 are listed. For example, one transaction has a transaction date 302 of “Jul. 26, 2010” 304 and reports an amount of “387.00” 306.

The information needed for a non-accountant user is available in the system, but the information may be difficult for a non-accountant user to retrieve and to interpret.

### SUMMARY

Therefore, there is a need in the art for the following methods, computer readable medium, and apparatuses.

A method of interacting with a user on a computer for displaying general ledger funds is disclosed. The term “general ledger fund” is understood to mean a fund in a general ledger where a grant is an example of a fund. The term “grant” is understood to mean the disbursement of money by one party (grantor) to another party (grantee). The grantor may be, for example, a government agency, a business entity, an individual, or a nonprofit entity such as a foundation or trust. The grantee may comprise, for example, an individual, a for-profit entity, or non-profit entity such as a university. The term “fund” may include not only grants but accounts in the general ledger where money is received for goods or services. The disclosed method may comprise displaying general ledger funds with an icon indicating a balance of the general ledger fund; and in response to a selection of one of the displayed general ledger funds comprising transactions by the user, displaying transactions of the selected general ledger fund in a row comprising a column for transactions that lower the balance, a column for transactions that raise the general ledger fund balance, and a column for the balance, and displaying an icon for the column for transactions that lowers the balance and an icon for the column for transactions that raises the balance.

In response to a selection of one of the displayed general ledger funds may further comprise retrieving from a ledger of the selected general ledger fund credits and debits and displaying in the column for transactions that lower the balance, credits and debits that lower the balance of the selected general ledger fund, and displaying in the column for transactions that raise the balance, credits and debits that raise the balance of the selected general ledger fund.

The icon indicating the balance of the general ledger fund may be an up arrow if the general ledger fund balance is positive, a down arrow if the general ledger fund balance is negative, and an equal sign if the general ledger fund value is zero.

The method of claim 1, wherein the icon for transactions that lower the balance is a negative sign, and the icon for transactions that raise the balance is a plus sign.

The transactions of the selected general ledger fund may be displayed chronologically with a most recent transaction on top.

Displaying general ledger funds with an icon indicating a balance of the general ledger fund may comprise displaying general ledger funds with an icon indicating a balance of the general ledger fund and an icon indicating further details.

The icon indicating further details may be an illustration of a drill.

In embodiments the general ledger funds may be a grant.

A computer system for displaying general ledger fund information in a checkbook format is disclosed. The computer system may comprise a processor adapted to: display general ledger funds with an icon indicating a balance of the general ledger fund; and respond to a selection of one of the displayed general ledger funds by the user, by displaying transactions of the selected general ledger fund in a row comprising a column for transactions that lower the balance, a column for transactions that raise the balance, and a column for the balance, and by displaying an icon for transactions that lower the balance and an icon for transactions that raise the balance.

The processor may further be adapted to: retrieve from a ledger of the selected general ledger fund credits and debits and display in the column for transactions that lower the balance credits and debits that lower the balance of the selected general ledger fund, and display in the column for transactions that raise the balance, credits and debits that raise the balance of the selected general ledger fund.

A computer program product is provided. The computer program product may comprise a computer-readable medium comprising: a first set of codes for displaying general ledger funds with an icon indicating a balance of the general ledger fund; and a second set of codes for responding to a selection of one of the displayed general ledger funds by the user, by displaying transactions of the selected general ledger fund in a row comprising a column for transactions that lower the balance, a column for transactions that raise the balance, and a column for the balance, and displaying an icon for transactions that lower the balance and an icon for transactions that raise the balance.

### BRIEF DESCRIPTION OF THE DRAWING

The following detailed description can be read in connection with the accompanying drawings in which like numerals designate like elements and in which:

FIG. 1 illustrates a financial query screen in existing enterprise resource planning system;

FIG. 2 illustrates the results of the query from FIG. 1;

FIG. 3 illustrates the results of a user selecting an account;

FIG. 4 illustrates a logon screen to an accounting system of an embodiment of the invention;

FIG. 5 illustrates a home screen of an accounting system of an embodiment of the invention where a user has logged onto the accounting system;

FIG. 6 illustrates a checkbook screen of an accounting system of an embodiment of the invention of FIG. 5 where the “Checkbook” tab has been selected;

FIG. 7 illustrates a drill down screen according to an embodiment of the invention;

FIG. 8A illustrates a drilldown screen with details of a transaction being displayed;

FIG. 8B illustrates a more information screen with details of a transaction being displayed;

FIG. 9 illustrates a method of interacting with a user for displaying general ledger fund information;

FIG. 10 illustrates a system for displaying general ledger fund information;

FIG. 11 is a simplified functional block diagram of a computer system.

### DETAILED DESCRIPTION

Although described in connection with preferred embodiments thereof, it will be appreciated by those skilled in the art that additions, deletions, modifications, and substitutions not specifically described may be made without departure from the spirit and scope of the invention as defined in the appended claims.

FIGS. 4-8 illustrate an embodiment of the invention. FIG. 4 illustrates a logon screen 400 to an accounting system of an embodiment of the invention. The logon screen 400 includes a “Home” tab 406, a “Checkbook” tab 408, and a “Utilities” tab 410. As illustrated, the “Home” tab 406 is selected. The logon screen also includes a “User name” box 402, where a user has entered a user name “research213”, and a “Password” box 404, where a user has entered a password. A user enters a user name in the “User name” box 402 and then enters a password in the “Password” box 404, and then selects “Login” 407 to login to the accounting system.

FIG. 5 illustrates a home screen 500 of an accounting system of an embodiment of the invention where a user has logged onto the accounting system. The home screen 500 may include a budget 502, a “Home” tab 406, a “Checkbook” tab 408, and a “Utilities” tab 410. As illustrated, the “Home” tab 406 is selected. The budget 502 provides an overview of the award budgets for the organization, which in the case is a university. The budget 502 includes a table with schools 504, which are the schools of the university, and award budget 506. Selection of the “Checkbook” tab 408 displays a checkbook screen (FIG. 6), and selection of the “Utilities” tab 410 displays a utilities screen (not illustrated.)

FIG. 6 illustrates a checkbook screen 600 of an accounting system of an embodiment of the invention of FIG. 5 where the “Checkbook” tab 408 has been selected. The checkbook screen 600 displays general ledger funds, which in this case are grants 615 in a grant table 654 according to filters 602, 604, and 608.

The checkbook screen 600 includes tabs 406, 408, and 410; filters “Grants” 602, “Status” 604, and “Amount” 606; and, a grant table 654. The tabs include a “Home” tab 406, a “Checkbook” tab 408, and a “Utilities” tab 410. As illustrated in FIG. 6, the “Checkbook” tab 408 is selected. See FIG. 5 for the “Home” tab 406 being selected. The “Utilities” tab 410 is not illustrated.

The filters include a “Grants” box 602, a “Status” 604 box, and an “Amount” box 606. The “Grants” box 602, “Status” 604 box, and “Amount” box 606, can be used to filter the results of the grant table 654. For example, selecting the button on the “Grants” box 602 makes a pull-down menu display with a list of all the grants 615, which enable selection of one or more grants 615. Additionally, the user can enter numbers into the “Grants” box 602 which may result in all the grants 615 that partially match the entered numbers to be displayed in the grant table 654. The “Status” box 604 enables filtering on the status of the grants 615. In embodiments, the “Status” may have five values of closed, close-out, active, advance, or no budget. Selection of or entering a status in the “Status” box 604 results in only the grants 615 that match the selected status being displayed in the grant table 654. The “Amount” box 606 enables filtering on an entered amount of “Grant Balance” 614. In embodiments, the pull-down menu of the “Amount” box 606 is populated with equal to zero, less than zero, and greater than zero. Selection of an amount from the pull-down menu of the “Amount” box 606 or entering a number in the “Amount” box 606 may result in all the grants 615 that match the selected or entered amount being displayed in the grant table 654. In embodiments, the grant table 654 defaults to displaying all grants 615 if there are no filters 602, 604, or 606 set. The grants 615 displayed in the grant table 654 may be limited to those grants that the user who logged on to the accounting system with user name 402 (FIG. 4) is authorized to view. In embodiments, the filters enable the user to enter wild card characters and enable partial matches.

The grant listing area 654 includes a listing of grants 615. The grant may include a “Grant Code” 608, a “Agency Name” 610, a “Grant Title” 612, a “Grant Balance” 614, a drill down icon 618, and a balance indicator icon 624. In addition, other columns may be included. For example, the following columns may optionally be included, “Grant Analyst”, “Grant Status”, “Principal Investigator”, and “Sponsor ID.” The “Grant Code” 608 may be a code used for the grant 615. The “Agency Name” 610 may be the source of the grant 615. The “Grant Title” 612 may be a title for the grant 615. The “Grant Balance” 614 may be a balance for the grant 615. The drill down icon 618 may be an icon of a drill. Other icons may be used, for example, an arrow. The balance indicator icon 624 may be an up arrow 624 if the “Grant Balance” is positive, a down arrow 630 if the “Grant Balance” is negative, and an equal sign 628 if the “Grant Balance” is zero.

Grant 615 is displayed as one line of the grant table 654. As illustrated, grant 615 has “Grant Code” 608 of “240055” 616, drill down icon 618 of a drill, “Agency Name” 610 of “American Heart Association” 620, “Grant Title” 612 of “Signal Cross-Talk of Aniotensin II”, “Grant Balance” 614 of “11,069.28”, and a balance indicator icon 624 of an up arrow 624, which may be green. The balance indicator icon 624 is an up arrow 624 because the “Grant Balance” 614 is “11,069.28”, which is a positive grant balance amount. In embodiments, the checkbook screen 600 may include a field for a principal investigator and may include a filter based on the principal investigator.

The checkbook screen 600 provides the advantage that a user does not have to remember a “Grant Code” 608 since the grants 615 are listed in a grant table 654. Additionally, the user can use the filters 602, 604, 606, to find grants 615 that the user is interested in. The checkbook screen 600 provides the additional advantage that the balance indicator icon 624 offers a quick visual way for the user to discern the “Grant Balance” 614 for the grants 615 listed in the grant table 654. The checkbook screen 600 provides the additional advantage that a user may select the drill down icon 618 to display a list of transactions for the grant 615. In embodiments, the checkbook screen 600 displays a “Total Available Balance”, a “Salary Accounts”, and “Total Available in Non-Salary Accounts”. This provides the advantage of providing salary vs. non-salary information for the user who may not be able to control salary accounts but may be able to control non-salary accounts.

FIG. 7 illustrates a drill down screen 700 according to an embodiment of the invention. Drilldown screen 700 may have been displayed in response to a user selecting the drill down icon 618 of grant 615 displayed in FIG. 6. The drilldown screen 700 displays a list of transactions 702 associated with the grant code 704 in a checkbook type of format where the last transaction may be listed on top.

The drill down screen 700 includes a title of “DRILLDOWN SCREEN WITH DETAILS”, a grant code 704 of “240055”, a “Grant Balance” 708 of “19,615.35”, a table of transactions 710, which list transactions 712. In embodiments, the table of transactions 710 may include a column for the “Date” 714, a column for a “Document” 716, a column for “Account” 718, a column for “Description” 720, a column for “−” 722, a column for “+” 724, and a column for “Balance” 726. The “Date” 714 is the date for the transaction 712. The “Date” 714 may include an icon for further details such as a “+” 732. The selection of the “+” 732 will display further details regarding the transaction. The “Document” 716 is a document name that includes further detail regarding the transaction 712. The “Account” 718 is a number for the account that the transaction 712 is posted to. The “Description” 720 is a description of the transaction. The “−” is a column for transaction amounts that are negative or reduce the grant balance 708. The “+” is a column for transaction amounts that are positive or increase the grant balance 708. The “Balance” 726 is a current balance of the grant 708 after the transaction 712.

An example transaction 712 has a date 714 of “May 27, 2011 10:41 AM” 730, which is the date 714 the transaction 712 occurred. A “Document” 716 of “AP000149” 734, which is a document containing details of the transaction 712. An “Account” 718 of “7240” 736, which is an account the transaction 712 was posted to in the accounting system. A “Description” 720 of “JPM0002052498WKH*”, which is a description 720 of the transaction 712. A “−” 724 of “(350.00)” 740, which is the amount of the transaction and placed in the “−” column because the transaction 712 reduces the grant balance 708. A “+” of blank because the amount of the transaction does not increase the grant balance 708. Finally, a “Balance” 726 of “21,261.51” 744, which is the amount of the grant balance 708 after the transaction 712.

In embodiments, the transactions 712 are displayed with the most recent transaction on top 728. In embodiments, transaction amounts 722, 724 are displayed in a color indicating whether the transaction increases or decreases the grant balance 708. For example, the numbers in the “−” column 722 may be in red and the numbers in the “+” column 724 may be in green. In embodiments, different icons are used for the interface 700. For example, rather than a “−” icon, a down arrow icon may be used, and rather than a “+” icon, an up arrow icon may be used.

The drilldown screen 700 has the advantage that a user can conveniently look at the table of transactions 710 displayed in a checkbook format to examine the transactions 712, and determine how the transactions 712 affect the grant balance 708. The familiar format of a checkbook format with the use of the “+” and “-” icons enables users that are unfamiliar with accounting principles to manage their grant without learning accounting. For example, a user may examine transaction 712 with account “7240” 736 and the affect it has on the grant balance 708 without additional selections and without understanding double entry accounting or the use of account names such as “Business Supplies and Service” 208 (FIG. 2) that may have been created by a manager of the accounting system.

In contrast, in conventional methods, a user must first enter an grant number (see FIG. 1), and then be presented with a list of accounts of the accounting system that may not have been constructed by the user (see FIG. 2), and then select an account (see FIG. 3). For example, in order for a user to examine transaction 304 of FIG. 3 (which is the same transaction as 712 of FIG. 7), the user must click on account 7240 “Business Supplies and Service” 208 of FIG. 2.

FIG. 8A illustrates a drilldown screen 800 with details of a transaction being displayed. The drilldown screen with details 800 may be displayed in response to a user selecting the “+” icon for transaction 728 (see FIG. 7). FIG. 8A illustrates further details for transaction 728, which may include a title 802. The further details may include an image icon 804, a print the transaction icon 806, an email icon 808, and a more information icon 810. Selection of the image icon 804 may display an image of the transaction details. For example, the image of the transaction details may be a canceled check. In embodiments, a different icon may be used for the image icon 804. Selection of the print the transaction icon 806 may print the transaction 728. In embodiments, a different icon may be used for the print the transaction icon 806. Selection of the email icon 808 may email the transaction 728. In embodiments, the email icon 808 may not be displayed to avoid displaying confidential information. In embodiments, a different icon may be used for the email icon 808. Selection of the more information icon 810 may provide additional information for the transaction 728 including accounting system information, program information, and may display fields that are cropped in the display of FIG. 7 more fully. In embodiments, a different icon may be used for the more information icon 810. Selection of the more information icon 810 may result in the more information screen 820 of FIG. 8B being displayed. Selection of the “−” icon for transaction 728 may result in the screen in FIG. 7 being displayed. In embodiments, a drilldown screen with details 800 may be different for an employee encumbrance. For example, an employee drilldown screen with details 800 may include the employee name, employee identification, employee position, employee position number, transaction date, and fiscal year, as well an image icon 804, a print the transaction icon 806, an email icon 808, and a more information icon 810. Selection of the more information icon 180 in the employee drilldown screen may provide additional details such as purchase order, requestor, organization, ship to address, and a balance on the encumbrance.

FIG. 8B illustrates a more information screen 820 with details of a transaction being displayed. The more information screen 820 may be displayed in response to a user selecting the more information icon 810 of FIG. 8A. The more information screen 820 may include a “Vendor Number” 822, which may be a number identifying the vender in the accounting system, a “Vendor Name” 824, which may be the name of the vendor as discussed in relation to FIG. 8, a “Vendor Address” 826, which may be the address of the vendor, an “Invoice Number” 828, which may be an invoice number identifying the invoice, an “Invoice Date” 830, which may be a date of the invoice, a “Commodity Description” 832, which may be a description of the commodity the invoice is for, a “Purchase Order”, which may be a purchase order identifying the purchase in the accounting system, and a “Paid” 836, which may indicate whether or not the money has actually been transferred to the vendor.

FIG. 9 illustrates a method of interacting with a user for displaying grant information. The method begins at step 910 with displaying general ledger funds with an icon indicating a balance of the general ledger fund. FIG. 6 is an example of general ledger funds being displayed in a table of grants 654 with an icon 624, 628, and 630 indicating the balance of the grant. As discussed in connection with FIG. 6, the grants 615 displayed may be selected from an accounting system based on a user name 402 (FIG. 4), and three icons may be used to indicate the grant balance: an up arrow 624 to indicate a grant has a positive balance, an equal sign 628 to indicate a grant has a zero balance, and a down arrow 630 to indicate a grant balance is negative.

The method continues at 920 with in response to a selection of one of the displayed general ledger funds by the user, displaying transactions of the selected general ledger fund in a row comprising a column for transactions that lower the balance, a column for transactions that raise the balance, and a column for the balance, and displaying an icon for transactions that lower the balance and an icon for transactions that raise the balance. FIG. 7 illustrates the result of a user selecting grant “240055” 615 of FIG. 6. Displayed in FIG. 7 are transactions 712 in a transaction table 710 of the selected grant “240055” 704. The transactions 712 are displayed in a row 712 with a column for transaction that lower the balance 722, and an icon 722 that indicates the column for transaction that lower the balance and an icon 724 that indicates the column for transactions that raise the balance.

Optionally, the method may comprise the following steps, retrieving credits and debits from a ledger of the selected general ledger fund; and displaying in the column for transactions that lower the balance, credits and debits that lower the balance of the selected general ledger fund, and displaying in the column for transactions that raise the balance, credits and debits that raise the balance of the selected general ledger fund. For example, a system for displaying general ledger fund information may retrieve information from a ledger stored in a database and convert credits and debits and display in the column for transactions that lower the balance, credits and debits that lower the balance of the selected general ledger fund, and display in the column for transactions that raise the balance, credits and debits that raise the balance of the selected general ledger fund.

The method 900 has the advantage that a user can conveniently examine the accounting records of a general ledger fund without having to understand a ledger.

FIG. 10 illustrates a system for displaying general ledger fund. The system for displaying general ledger fund information includes a user computer 1012, communication connections 1014, 1016, a server 1002, a display general ledger fund information 1004, which comprises a user interface generator 1006, an accounting system converter 1008, and a database access 1010. A user computer 1012 sends requests for general ledger fund information to a server 1002 executing display general ledger fund information 1004, which responds to the requests for general ledger fund information by accessing database 1070.

User computer 1012 may be a personal computer, laptop, tablet computer, or other computing device. The user computer 1012 may be running a web browser that is used to access the server 1002. The server 1002 may be a server computer. The server 1002 may be executing display general ledger fund information 1004. The server 1002 may be executing a web service system such as .Net™ by Microsoft. The display general ledger fund information 1004 may be software implemented in a higher level language. The user interface generator 1006 may generate user interfaces for the user computer 1012 to display to the user. The user interface generator 1006 may be implemented in Adobe Flex™ framework. The accounting system converter 1008 may convert from an accounting system stored in a database 1070 to a format appropriate for the display general ledger fund information 1004. For example, the accounting system converter 1008 may retrieve information from a ledger for a general ledger fund stored in database 1070 and convert credits and debits so that credits and debits that lower the balance of the general ledger fund will be displayed in a column for transactions that lower the balance of the general ledger fund, and so that credits and debits that raise the balance of the general ledger fund will be displayed in a column of transactions that raise the balance of the general ledger fund. For example, the accounting system converter 1008 may retrieve all the ledger information for general ledger fund “240055”, which in this example was a grant. The accounting system converter 1008 would examine each of the credit and debit pairs and determine whether or not the transaction lowered or raised the general ledger fund balance. For example, accounting system converter 1008 would examine transaction 304 (FIG. 3) and determine that transaction 304 lowers the general ledger fund balance, which in this example was a grant balance, and thus should be displayed in the column for the grant that indicates the transaction lowers the grant balance.

The database access 1010 may access the database 1070 in a database access language such as SQL. The database 1070 may be a database for an accounting system implemented in, for example, Oracle or MySQL. The database 1070 may be access by another computer running an accounting system with the accounting system stored as a ledger. The communication connections 1014, 1016 may be Internet, intranet other types of communication connections that enable two or more computers to communicate.

FIG. 11 is a simplified functional block diagram of a computer system 1100. The system for behavior modification can be implemented in hardware, software or some combination thereof.

As shown in FIG. 11, the computer system 1100 includes a processor 1102, a memory system 1104 and one or more input/output (I/O) devices 1106 in communication by a communication “fabric.” The communication fabric can be implemented in a variety of ways and may include one or more computer buses 1108, 1110 and/or bridge devices 1112 as shown in FIG. 11. The I/O devices 1106 can include network adapters and/or mass storage devices. Referring to FIGS. 10 and 11, the computer system 1000 may receive requests to display general ledger fund information over the network adapters 1106. The display general ledger fund information 1004 may reside on memory system 1104 and/or may be accessed via I/O devices 1106, or may reside on a mass storage device that is accessible via the communication fabric and part of the I/O devices 1106, which may be either local such as a hard disk in the same room as the processor 1102 or may be located remotely such as in a memory system such as a hard disk remotely located in a service center. The user computer 1012 may be accessed via I/O devices 1106. The display general ledger fund information 1004 may access the database 1070 via I/O devices 1106. The database 1070 may be stored on a separate computer system or may reside on memory system 1104 accessible to the display general ledger fund information 1004. The communication fabric may be in communication with many networks including the Internet and local area networks.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of instructions on a machine readable medium and/or computer readable medium, which may be in a physical form.

Although described in connection with preferred embodiments thereof, it will be appreciated by those skilled in the art that additions, deletions, modifications, and substitutions not specifically described may be made without departure from the spirit and scope of the invention as defined in the appended claims.

What is claimed is:

1. A method of interacting with a user on a computer for displaying general ledger funds,
displaying general ledger funds with an icon indicating a balance of the general ledger fund; and
in response to a selection of one of the displayed general ledger funds comprising transactions by the user, displaying transactions of the selected general ledger fund in a row comprising a column for transactions that lower the balance, a column for transactions that raise the balance, and a column for the balance, and displaying an icon for the column for transactions that lowers the balance and an icon for the column for transactions that raises the balance.

2. The method of claim 1, wherein in response to a selection of one of the displayed general ledger funds further comprises:
retrieving from a ledger of the selected general ledger fund credits and debits and displaying in the column for transactions that lower the balance, credits and debits that lower the balance of the selected general ledger fund, and displaying in the column for transactions that raise the balance, credits and debits that raise the balance of the selected general ledger fund.

3. The method of claim 1, wherein the icon indicating the balance of the general ledger fund is an up arrow if the general ledger fund balance is positive, a down arrow if the general ledger fund balance is negative, and an equal sign if the general ledger fund value is zero.

4. The method of claim 1, wherein the icon for transactions that lower the balance is a negative sign, and the icon for transactions that raise the balance is a plus sign.

5. The method of claim 1, wherein the transactions of the selected general ledger fund are displayed chronologically with a most recent transaction on top.

6. The method of claim 1, wherein displaying general ledger funds with an icon indicating a balance of the general ledger fund, further comprises:
displaying general ledger funds with an icon indicating a balance of the general ledger fund and a further details icon, wherein selection of the further details icon results in further details of the general ledger fund being displayed.

7. The method of claim 6, wherein the further details icon is an illustration of a drill.

8. The method of claim 1, wherein the general ledger fund is a grant.

9. A computer system for displaying general ledger funds in a checkbook format, the system comprising:
a processor adapted to:
display general ledger funds with an icon indicating a balance of the general ledger fund; and
respond to a selection of one of the displayed general ledger funds by the user, by displaying transactions of the selected general ledger fund in a row comprising a column for transactions that lower the balance, a column for transactions that raise the balance, and a column for the balance, and by displaying an icon for transactions that lower the balance and an icon for transactions that raise the balance.

10. The computer system of claim 9, wherein the processor is further adapted to:
retrieve from a ledger of the selected general ledger fund credits and debits and display in the column for transactions that lower the balance credits and debits that lower the balance of the selected general ledger fund, and display in the column for transactions that raise the balance, credits and debits that raise the balance of the selected general ledger fund.

11. The computer system of claim 9 for displaying general ledger funds in a checkbook format, wherein the general ledger funds are grants.

12. A computer program product, comprising:
a computer-readable medium comprising:
a first set of codes for displaying general ledger funds with an icon indicating a balance of the general ledger fund; and
a second set of codes for responding to a selection of one of the displayed general ledger funds by the user, by displaying transactions of the selected general ledger fund in a row comprising a column for transactions that lower the balance, a column for transactions that raise the balance, and a column for the balance, and displaying an icon for transactions that lower the balance and an icon for transactions that raise the balance.
